(19) United States
(12) Patent Application Publication
(10) Pub. No.: US 2010/0332550 A1
(43) Pub. Date: Dec. 30, 2010

(54) Platform For Configurable Logging Instrumentation

(75) Inventor: Charles Ainslie, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/492,704

(22) Filed: Jun. 26, 2009

(51) Int. Cl. G06F 15/16; G06F 17/30; G06F 9/46

(52) U.S. Cl. 707/802; 719/318; 709/224; 707/791; 707/803; 707/812

(57) ABSTRACT

A configurable logging platform may be provided. A logging object may be embedded in a web page. When the page is rendered, the logging object may retrieve a remote configuration file comprising at least one logging action. An event handler may be added to the rendered web page in order to capture a user behavior associated with the logging action. The captured user behavior may be stored by the logging object and transmitted to a logging database.

### RELATED APPLICATIONS

Related U.S. patent application Ser. No. ______, filed on even date herewith entitled “Web Usage Pattern Insight Platform,” assigned to the assignee of the present application and having attorney docket number 14917.1299US01/MS327291.01, is hereby incorporated by reference.

Related U.S. patent application Ser. No. ______, filed on even date herewith entitled “Best-Bet Recommendations,” assigned to the assignee of the present application and having attorney docket number 14917.1303US01/MS327295.01, is hereby incorporated by reference.

Related U.S. patent application Ser. No. ______, filed on even date herewith entitled “Batched Transfer of Arbitrarily Distributed Data,” assigned to the assignee of the present application and having attorney docket number 14917.1304US01/MS327296.01, is hereby incorporated by reference.

Related U.S. patent application Ser. No. ______, filed on even date herewith entitled “______,” assigned to the assignee of the present application and having attorney docket number 14917.1305US01/MS327316.01, is hereby incorporated by reference.

Related U.S. patent application Ser. No. ______, filed on even date herewith entitled “Load-Balancing and Scaling for Analytics Data,” assigned to the assignee of the present application and having attorney docket number 14917.1306US01/MS327318.01, is hereby incorporated by reference.

### BACKGROUND

A configurable logging instrumentation platform is a means for tracking how users use a web site. For example, sites may wish to track which pages are viewed, how long pages are viewed, what links, buttons, and other objects are selected on a page, and other interactive activity occurs. Conventional systems clutter up a site's content with embedded logging instrumentation to collect this information. This often causes problems because it is difficult to track and maintain when requirements, such as what data to track or where to store the data, change. For example, as logging requirements change, every page in a site may need to be re-coded and updated.

### SUMMARY

A configurable logging instrumentation platform may be provided. This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

A configurable logging platform may be provided. A logging object may be embedded in a web page. When the page is rendered, the logging object may retrieve a remote configuration file comprising a logging action. An event handler may be added to the rendered web page in order to capture a user behavior associated with the logging action. The captured user behavior may be stored by the logging object and transmitted to a logging database.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing a configurable logging platform; and

FIG. 3 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

A configurable logging instrumentation platform may be provided. Consistent with embodiments of the present invention, a logging system may be decoupled from the individual pages of a web site that are being monitored. Each monitored page may comprise an embedded logging object, in JavaScript™, for example. When the page is loaded by a user in a web browser, the logging object may retrieve a configuration file from a remote source and add event handlers to page elements, such as controls, images, links, or other embedded objects, of interest. The event handlers may capture user interactions with the page elements, store the captured behavior locally, and send the stored behavior to a remote logging database.

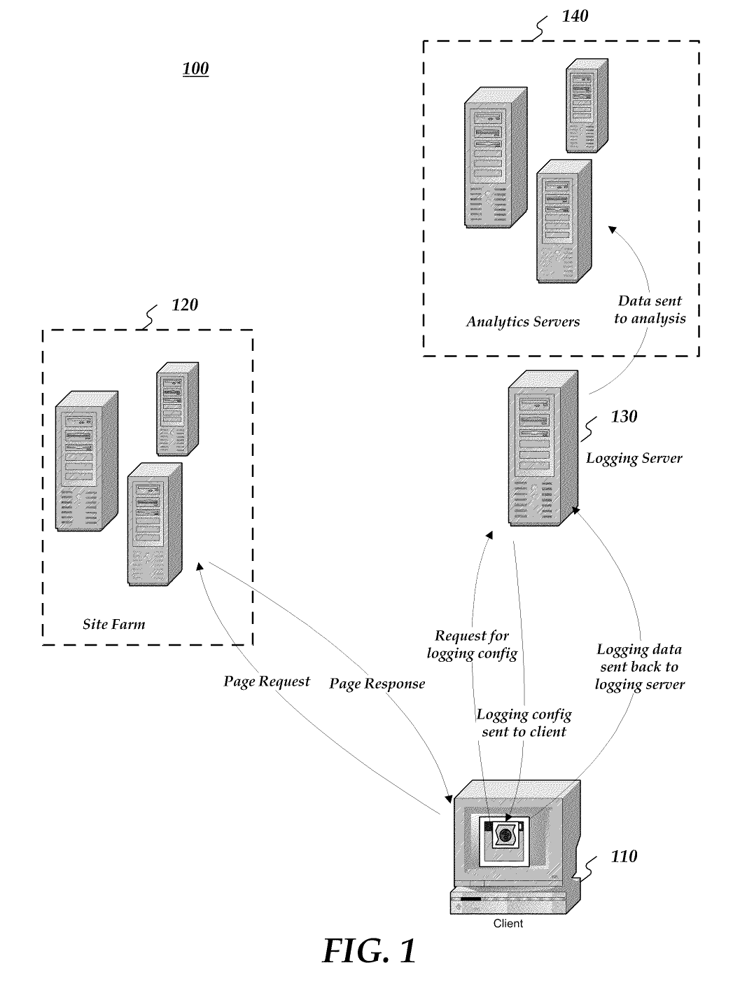

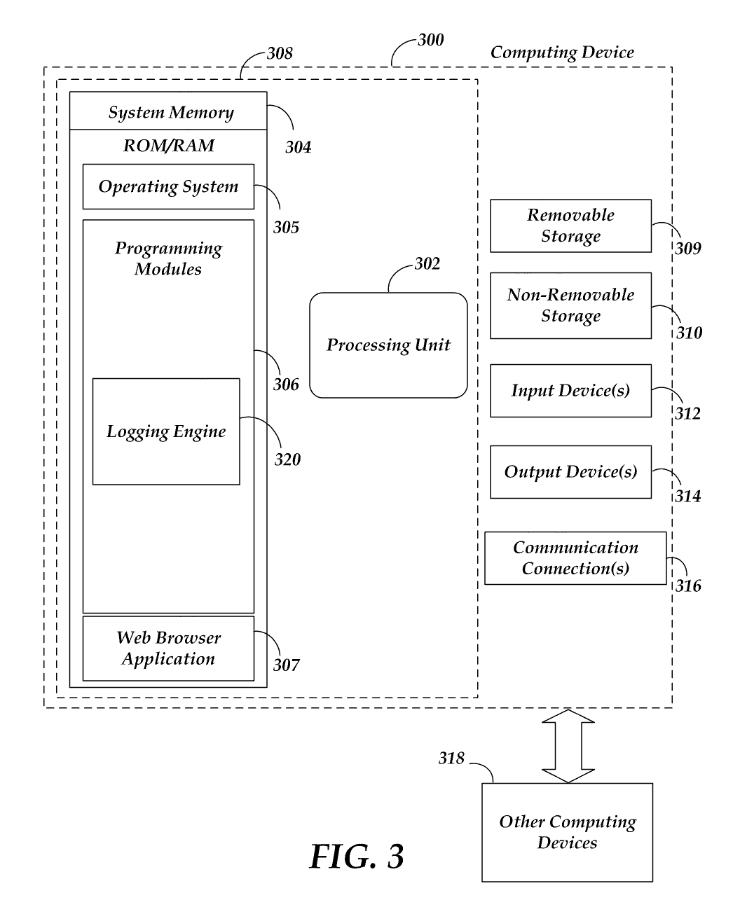

FIG. 1 is a block diagram of an operating environment 100. Operating environment 100 may comprise a client device 110, a web site farm 120, a logging server 130, and an analytics server 140. Client device 110 may comprise, for example, a computing device 300 such as that described in greater detail below with respect to FIG. 3. Web site farm 120 may comprise one and/or a plurality of server computers operative to host web pages associated with one and/or more web sites. Client device 110, web site farm 120, logging server 130, and analytics server 140 may be in communication with each other over a computing network or other communications medium. For example, client device 110 may be operative to request and retrieve a web page from a web server associated with site farm 120 via the network.

The retrieved web page may comprise a plurality of rendering instructions encoded in a markup language, such as HyperText Markup Language (HTML). The markup language may provide a means to describe the structure of text-based information in a document by identifying the structure of text elements as links, headings, paragraphs, lists. The markup language may also supplement the text with objects such as form controls, images, and executable scripts. Executable scripts may enable programmatic access to other objects on the page and to hardware and/or software associated with client device 110. For example, a logging object may be operative to detect activities associated with user interface devices attached to client device 110, such as a keyboard and/or mouse, and store the detected activity on a local storage device, such as RAM and/or a hard drive.

Consistent with embodiments of the invention, client device 110 may be further operative to retrieve a logging configuration file from web site farm 120 and/or logging server 130 based on a rendering instruction included within the requested web page. The logging configuration file may comprise a text file encoded in a schema language, such as Extensible Markup Language (XML) and/or JavaScript Object Notation (JSON). The configuration file may identify one and/or more page elements and/or events to be monitored for user behaviors. The logging object may be operative to read the configuration file and add event handlers to the web page. For example, the logging object may add a dwell time monitor operative to measure how long the user keeps the page open, a link monitor to log whether the user selects a link included in the web page, and/or a scroll activity monitor to determine whether the user is actively scrolling through the web page.

Captured user behavior, such as where a user selects a form control, may be stored by client device 110 and transmitted to logging server 130. Each page element and/or event handler may be associated with a unique identifier. This identifier may be included in the log entry associated with the captured user behavior and transmitted to logging server 130. Logging server 130 may be operative to process log entries received from a plurality of client devices and/or a plurality of web site and/or pages. Processing may comprise, for example, sorting, filtering, concatenating, and/or aggregating the log entries. Many other actions are possible for processing the log entries, and this list is not intended to be limiting. Logging server 130 may be operative to send the log data, before and/or after processing, to analytics server 140 for insight analysis, such as evaluations of the usefulness, popularity, and/or relevance of monitored pages and/or page elements.

Consistent with embodiments of the invention, client device 110 may be operative to provide a user with the option to disable the capture, logging, and/or transmission of the user's behavior. For example, a web browser application may request user permission to share the captured behavior and/or provide a user with a privacy preferences option that may disable the logging object.

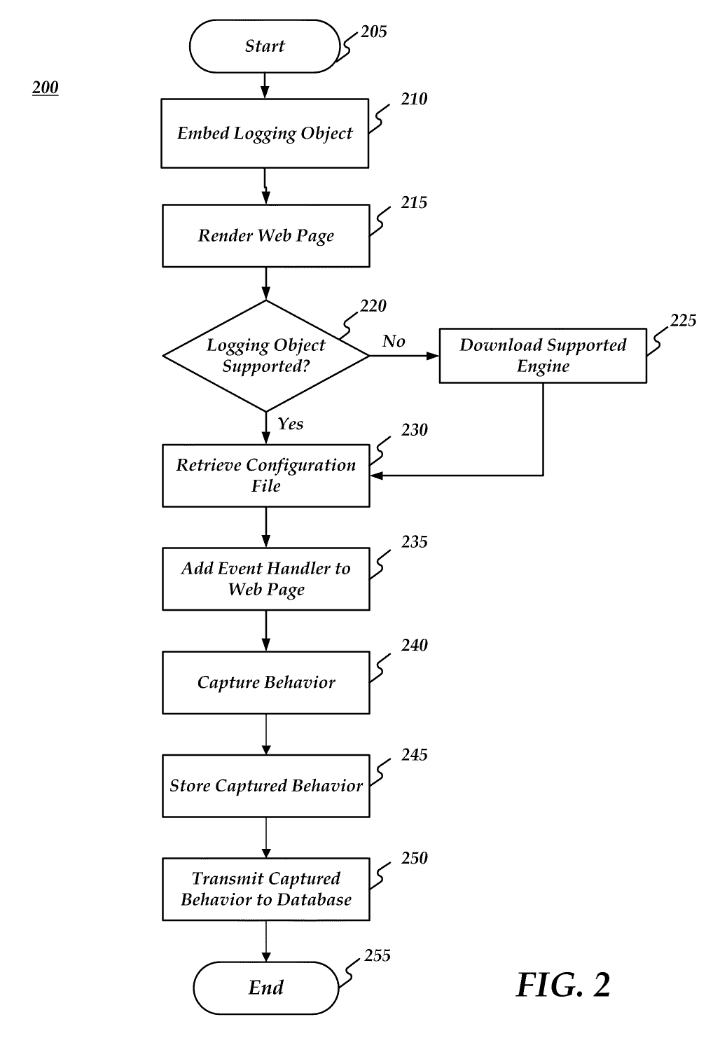

FIG. 2 is a flow chart setting forth the general stages involved in a method 200 consistent with an embodiment of the invention for providing a configurable logging platform. Method 200 may be implemented using a plurality of computing devices such as computing device 300 as described in more detail below with respect to FIG. 3. For example, a web server associated with site farm 120, logging server 130, analytics server 140, and client device 110 may each comprise a computing device such as that described by computing device 300. Ways to implement the stages of method 200 will be described in greater detail below from the perspective of computing device 300 with the understanding that different physical computing devices may be operative to perform different stages of method 200.

Method 200 may begin at starting block 205 and proceed to stage 210 where computing device 300 may embed a logging object in a web page. For example, a web server at site farm 120 may provide a plurality of web pages associated with an entity, business, individual, and/or organization. Each web page may include an HTML call to load the same logging object, such as a JavaScript™ or other scripting language object, using a <SCRIPT> tag.

The logging object may be configured to provide functions that may be called by a web browser when the page is loaded, such as a GetConfig( ) function that may retrieve a configuration file when passed a location for the configuration file and a SubmitData( ) function that may be operative to transmit stored logging information to logging server 130. The location of the configuration file may be expressed as a Uniform Resource Locator (URL), and each web page may be provided with its own configuration file URL. The SubmitData( ) function may receive an id associated with the client and/or a destination address for logging server 130.

From stage 210, where computing device 300 embedded the logging object, method 200 may advance to stage 215 where computing device 300 may render the web page. For example, a web browser application executing on client device 110 may request a web page from site farm 120 and receive the web page from site farm 120. The web browser application may then process the markup language of the web page for display on client device 110.

From stage 215, method 200 may advance to stage 220 where computing device 300 may determine whether the embedded logging object is supported. For example, client device 110 may determine whether the logging object comprises a supported object language known to client device 110. If, at stage 215, computing device 300 determines that the logging object does not comprise a supported object language, method 200 may advance to stage 225 where computing device may download and install a supported logging engine. For example, computing device 300 may comprise a mobile phone that may not support an embedded JavaScript™ object. The mobile phone may attempt to download a supported logging engine, from a repository specified in the web page, for example, and install it. The downloaded logging engine may be developed independently for client devices that may not support the standard embedded logging object.

Once computing device 300 determines that the logging object is supported at stage 220 or downloads a supported engine at stage 225, method 200 may advance to stage 230 where computing device 300 may retrieve a logging configuration file. For example, the web browser executing on client device 110 may execute the GetConfig( ) function of the embedded logging object to retrieve the logging configuration file from site farm 120. Consistent with embodiments of the invention, the configuration file may be retrieved from a different server than that from which the web page is retrieved. Both servers may be associated with site farm 120. Alternately, the configuration file may be retrieved from logging server 130. The file may comprise logging actions encoded in a logging schema using, for example, Extensible Markup Language (XML) or JavaScript Object Notation (JSON). The logging actions may identify events, behaviors, and page elements to monitor and log.

Consistent with aspects of the invention, web pages may share configuration files. For example, multiple pages served by site farm 120 may incorporate the same type of page elements and thus may need the same logging configuration. Where multiple pages reuse a configuration file, each page's elements may incorporate unique identifiers in order to differentiate the pages' logging data. For example, a first web page and a second web page may each comprise a news story and a “Send this story to a friend” hyperlink operative to prepare an email message to a user. The logging object of each page may monitor the view time of the page and track if and/or when the hyperlink is clicked. Each hyperlink may be associated with a unique element id that need not be specified in the configuration file, but may be inserted by the page author and/or a web server service using, e.g., the ID attribute of an anchor tag.

From stage 230, where computing device 300 retrieved the logging configuration file, method 200 may advance to stage 235 where computing device 300 may add an event handler to the web page. For example, the logging configuration file may specify that a user dwell time should be monitored. Computing device 300 may add an event handler that may record a load time of the web page and that may execute on a page unload event. Similarly, an event handler may be added to other page elements such as form objects and/or hyperlinks that may capture user behavior associated with those elements.

From stage 235, where computing device 300, method 200 may advance to stage 240 where computing device 300 may capture a user behavior associated with one of the logging actions specified by the configuration file. For example, the event handler added to the web page by client device 110 for monitoring a user dwell time on the page may cause the logging object to calculate a dwell time when the page is unloaded according to the page load time and the page unload time. Event handlers may also capture user behaviors such as user interface device events, element selection, manipulation, and/or interaction, scrolling activity within the web browser application, and/or a focus time (i.e. how long the web browser application is in focus on the client device with the requested web page displayed).

Once computing device 300 captures the user behavior in stage 240, method 200 may continue to stage 245 where computing device 300 may store the captured behavior. For example, client device 110 may write a log entry to a locally stored log file and/or a database. The captured behavior may be stored once the user behavior is completed, when the page is unloaded, and/or at a scheduled time such as writing all captured behaviors to storage on a periodic basis (e.g. every five minutes).

After computing device 300 stores the captured behavior in stage 245, method 200 may proceed to stage 250 where computing device 300 may transmit the captured behavior to a remote database. For example, client device 110 may send a copy of the stored log file or database to logging server 130. Consistent with embodiments of the invention, the logging data may be sent anytime after the behavior is captured, such as once the user behavior is completed, when the page is unloaded, and/or at a scheduled time. Client device 110 may store logging data associated with multiple pages in the same storage, for example, and send newly stored data to logging server 130 every five minutes, for example. Once computing device 300 sends the data to the logging server in stage 250, method 200 may then end at stage 255.

An embodiment consistent with the invention may comprise a system for providing a logging platform. The system may comprise a memory storage and a processing unit coupled to the memory storage. The processing unit may be operative to render a web page, retrieve a configuration file associated with a logging object embedded in the web page, and capture a user behavior according to the configuration file. The user behavior may be expressed as a logging action in a schema associated with the configuration file and may comprise, for example, a page element to monitor, a user event to monitor, a page dwell time, a page focus time, and a scroll activity monitor. The captured behavior may be stored, in a logging database, for example, and transmitted to a remote logging server. The remote logging server may be associated with the web page, such as by encoding an address of the remote server in the logging object. Each captured behavior may be associated with a unique element identifier to properly identify the page element with which the behavior occurred.

Another embodiment consistent with the invention may comprise a system for providing a configurable logging platform. The system may comprise a memory storage and a processing unit coupled to the memory storage. The processing unit may be operative to retrieve a web page comprising a logging object, retrieve a configuration file associated with the logging object, render the web page, add an event handler to a page element, log a user behavior associated with the web page by the event handler, and send the logged behavior to a logging server. The web page server, the server hosting the configuration file, and the logging server may comprise the same and/or different physical computing devices and may comprise different network and/or physical locations.

Yet another embodiment consistent with the invention may comprise a system for providing a configurable logging platform. The system may comprise a memory storage and a processing unit coupled to the memory storage. The processing unit may be operative to receive a requested webpage, retrieve a logging configuration file from a location specified by a logging object embedded in the web page, render the webpage, add an event handler to a page object, store a user event captured by the event handler in a client log, wherein the client log comprises at least one of the following: a database, a web browser cookie, and a text file, and transmit the client log to a database. The database may comprise a memory storage and a processing unit coupled to the memory storage, wherein the processing unit is operative to receive the client log from the client computing device, and prepare the client log for insight analysis.

FIG. 3 is a block diagram of a system including computing device 300. Consistent with an embodiment of the invention, the aforementioned memory storage and processing unit may be implemented in a computing device, such as computing device 300 of FIG. 3. Any suitable combination of hardware, software, or firmware may be used to implement the memory storage and processing unit. For example, the memory storage and processing unit may be implemented with computing device 300 or any of other computing devices 318, in combination with computing device 300. The aforementioned system, device, and processors are examples and other systems, devices, and processors may comprise the aforementioned memory storage and processing unit, consistent with embodiments of the invention. Furthermore, computing device 300 may comprise an operating environment for system 100 as described above. System 100 may operate in other environments and is not limited to computing device 300.

With reference to FIG. 3, a system consistent with an embodiment of the invention may include a computing device, such as computing device 300. In a basic configuration, computing device 300 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include a web browser application 320. Operating system 305, for example, may be suitable for controlling computing device 300's operation. In one embodiment, programming modules 306 may include a logging engine 320 embedded in a web page and/or installed on computing device 300. Furthermore, embodiments of the invention may be practiced in conjunction with a graphics library, other operating systems, or any other application program and is not limited to any particular application or system. This basic configuration is illustrated in FIG. 3 by those components within a dashed line 308.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also have input device(s) 312 such as a keyboard, a mouse, a pen, a sound input device, a touch input device, etc. Output device(s) 314 such as a display, speakers, a printer, etc. may also be included. The aforementioned devices are examples and others may be used.

Computing device 300 may also contain a communication connection 316 that may allow device 300 to communicate with other computing devices 318, such as over a network in a distributed computing environment, for example, an intranet or the Internet. Communication connection 316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 304, including operating system 305. While executing on processing unit 302, programming modules 306 (e.g. web browser application 307 and logging engine 320) may perform processes including, for example, one or more method 200's stages as described above. The aforementioned process is an example, and processing unit 302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing a logging platform, the method comprising:
embedding a logging object in each of a plurality of web pages;
rendering at least one of the plurality of web pages in an application associated with at least one client device;
in response to loading the at least one web page, retrieving a configuration file associated with the logging object comprising at least one logging action; and
capturing at least one user behavior according to the at least one logging action.

2. The method of claim 1, wherein the at least one of the plurality of web pages is retrieved from a first remote server and the configuration file is retrieved from a second remote server.

3. The method of claim 1, wherein the at least one logging action comprises at least one of the following: a page element to monitor, a user event to monitor, a page dwell time, a page focus time, a page metadata tag to capture, a browser identifier to capture, an operating system identifier to capture, a browser screen position to monitor, and a scroll activity monitor.

4. The method of claim 1, further comprising storing the captured at least one user behavior in a logging database.

5. The method of claim 4, wherein storing the captured at least one user behavior occurs in response to the at least one web page being unloaded.

6. The method of claim 4, wherein storing the captured at least one user behavior occurs in response to the at least one user behavior being completed.

7. The method of claim 4, wherein storing the captured at least one user behavior occurs at a scheduled time.

8. The method of claim 1, wherein the at least one client device comprises a computing device operative to execute the logging object code.

9. The method of claim 1, further comprising adding an event handler associated with the at least one logging action to the page on the client device, wherein the event handler is operative to capture the at least one user behavior.

10. The method of claim 7, wherein the event handler is further operative to transmit the captured at least one user behavior to a server associated with the web page.

11. The method of claim 7, wherein the event handler is further operative to transmit the captured at least one user behavior to a logging database.

12. The method of claim 7, wherein the event handler is associated with a unique element identifier.

13. The method of claim 1, wherein the configuration file comprises at least one of the following: Extensible Markup Language (XML) and JavaScript Object Notation (JSON).

14. A computer-readable medium which stores a set of instructions which when executed performs a method for providing a configurable logging platform, the method executed by the set of instructions comprising:
retrieving a web page, wherein the web page comprises a logging object;
retrieving a configuration file associated with the logging object comprising at least one user action to log;
rendering the web page;
adding, by the logging object, an event handler to the at least one element associated with the rendered web page;
logging at least one user behavior associated with the web page by the event handler; and
sending the logged at least one user behavior to a logging server.

15. The computer-readable medium of claim 14, wherein the web page is retrieved from a first remote location and the configuration file is retrieved from a second remote location.

16. The computer-readable medium of claim 15, wherein the logging server comprises a third remote location.

17. The computer-readable medium of claim 14, wherein sending the logged at least one user behavior occurs according to at least one of the following: in response to the web page being loaded, in response to the web page being unloaded, in response to the at least one user behavior being completed, and at a scheduled periodic interval.

18. The computer-readable medium of claim 14, further comprising: determining whether the logging object comprises a supported object language; and
in response to determining that the logging object does not comprise a supported object language, downloading a client logging engine operative to execute the functionality of the logging object.

19. The computer-readable medium of claim 18, wherein the supported object language comprises JavaScript.

20. A system for providing a configurable logging platform, the system comprising:
a server computing device comprising a memory storage and a processing unit coupled to the memory storage, wherein the processing unit is operative to:
receive a request from a client computing device for a web page, and
transmit the requested webpage to the client computing device, wherein the requested webpage comprises an embedded logging object specifying a location of a logging configuration file,
the client computing device comprising a memory storage and a processing unit coupled to the memory storage, wherein the processing unit is operative to:
receive the requested webpage,
retrieve the logging configuration file from the specified location,
render the requested webpage in an application executing on the client computing device, wherein being operative to render the requested webpage comprises being operative to add an event handler to at least one object associated with the requested webpage according to the retrieved logging configuration file,
store at least one user event captured by the event handler in a client log, wherein the client log comprises at least one of the following: a database, a web browser cookie, and a text file, and wherein the at least one user event comprises at least one of the following: a user interaction with the at least one object, a page dwell time, a page focus time, a scroll activity, a link selection, and a user interface device event associated with the application, and
transmit the client log to a database computing device at a time comprising at least one of the following: at a page unload, at a predetermined time interval specified in the logging configuration file, and immediately following the at least one user event; and
the database computing device comprising a memory storage and a processing unit coupled to the memory storage, wherein the processing unit is operative to:
receive the client log from the client computing device, and
prepare the client log for insight analysis.
